(19) United States
(12) Patent Application Publication
(10) Pub. No.: US 2012/0131630 A1
(43) Pub. Date: May 24, 2012

(54) CONTROL APPARATUS AND CONTROL METHOD

(76) Inventors: Takahiko NOZOE, Yokohama (JP); Hiroo OKAMOTO, Yokohama (JP); Koji KAMOGAWA, Yokohama (JP)

(21) Appl. No.: 13/293,283

(22) Filed: Nov. 10, 2011

(30) Foreign Application Priority Data
Nov. 24, 2010 (JP) 2010-260763

(51) Int. Cl. H04N 7/173

(52) U.S. Cl. 725/117

(57) ABSTRACT

A control method for controlling via a network a transmitting apparatus which transmits contents and a receiving apparatus which receives contents is configured to include the steps of acquiring chapter information which indicates scene partition positions of contents from the transmitting apparatus, and transmitting an instruction to the receiving apparatus to cause the receiving apparatus to reproduce the contents from a scene partition position of the contents indicated by the acquired chapter information.

### INCORPORATION BY REFERENCE

The present application claims priority from Japanese application JP2010-260763 filed on Nov. 24, 2010, the content of which is hereby incorporated by reference into this application.

### CROSS-REFERENCE TO RELATED APPLICATION

This application relates to U.S. patent application Serial Number being filed based on Japanese Patent Application No. 2010-260762 filed on Nov. 24, 2010, the entire content of which is incorporated herein by reference.

### BACKGROUND OF THE INVENTION

The present invention relates to transmitting and receiving of contents.

As regards the technical field of the present invention, US2006/0114761A, Ohkita et al. describes that its object is to “provide a reproducing apparatus which makes it possible for a user to suitably refer to contents stored in a plurality of AV devices or the like connected to a network and view the contents easily in units of packets.” And it describes that means for attaining the object is “a reproducing apparatus including a communication unit configured to perform communication with a device on a network, a reproducing unit configured to decode contents in units of packets and reproduce the contents, and a control unit configured to control to acquire management information (VR_MANGR. IFO) stored in the device on the network by controlling the communication unit, display the substance of the contents on the basis of the management information, receive a reproduction instruction from the user, acquire the contents on the device in units of packets via the communication unit in accordance with the reproduction instruction, and reproduce the packet of the acquired contents in the reproducing unit.”

### SUMMARY OF THE INVENTION

In US2006/0114761A, Ohkita et al., however, update of the management information is not taken into consideration and consequently the reproducing apparatus is not convenient for the user to use.

In order to solve the problem, configurations described in Claims are adopted.

The present invention includes a plurality of means for solving the problem. For example, a control method for controlling via a network a transmitting apparatus which transmits contents and a receiving apparatus which receives contents includes the steps of acquiring chapter information which indicates scene partition positions of contents from the transmitting apparatus, and transmitting an instruction to the receiving apparatus to cause the receiving apparatus to reproduce the contents from a scene partition position of the contents indicated by the acquired chapter information.

According to the means, it becomes possible in viewing of contents via a network to reproduce contents from a position which is convenient for the user, and convenience for the user to use can be improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration example of a system;

FIG. 2 is a block diagram showing a configuration example of a transmitting apparatus 110;

FIG. 3 is a block diagram showing a configuration example of a receiving apparatus 130/140;

FIG. 4 is a diagram showing an example of server device information delivered by the transmitting apparatus 110;

FIG. 5 is a diagram showing an example of service description information delivered by the transmitting apparatus 110;

FIG. 6 is a diagram showing an example of contents information including chapter information managed by the transmitting apparatus 110;

FIG. 7 is a flow chart showing an example of a series of procedures for giving and delivering chapter information to each other between the transmitting apparatus 110 and the receiving apparatus 130/140;

FIG. 8 is a diagram showing an example of a display screen of the receiving apparatus 130/140 for a user to conduct chapter operation;

FIG. 9 is a diagram showing an example of a configuration of attached information of contents data handled by the transmitting apparatus 110 and the receiving apparatus 130/140;

FIG. 10 is a diagram showing an example of a configuration of chapter information given and delivered between the transmitting apparatus 110 and the receiving apparatus 130/140;

FIG. 11 is a diagram showing an example of an apparatus obtained by incorporating the configurations of the transmitting apparatus 110 and the receiving apparatus 130/140 into one apparatus respectively as a transmitting unit and a receiving unit;

FIG. 12 is a block diagram showing a configuration example of a system;

FIG. 13 is a block diagram showing a configuration example, of a control apparatus 150; and

FIG. 14 is a flow chart showing an example of a series of procedures for giving and delivering chapter information to each other among the transmitting apparatus 110, the receiving apparatus 130/140, and the control apparatus 150.

### DESCRIPTION OF THE EMBODIMENTS

Hereafter, embodiments of the present invention will be described with reference to the drawings. By the way, the present invention is not restricted to the embodiments.

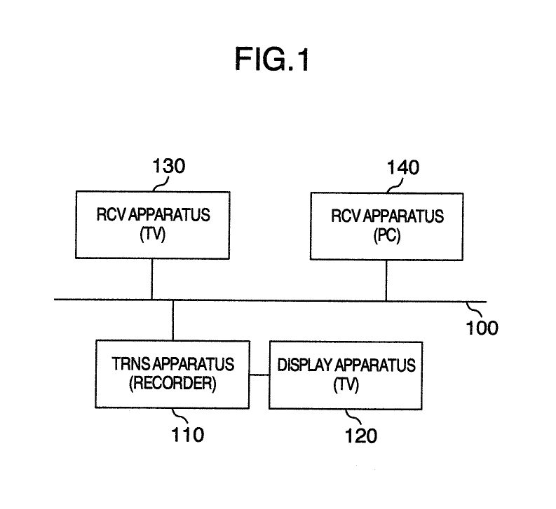

FIG. 1 shows a configuration example of a home network system formed of a transmitting (TRNS) apparatus and a receiving (RCV) apparatus according to an embodiment.

Reference numeral 110 denotes a transmitting apparatus (server) which transmits moving picture, voice and image contents to a receiving apparatus (a receiving apparatus 130/140 described later) on a home network 100. The transmitting apparatus (server) is an apparatus for managing chapter information (inf) which indicates scene partitions of contents according to the present embodiment.

As such a transmitting apparatus, for example, a recorder or a television set having a picture recording function is conceivable. In the case where the transmitting apparatus does not contain a display apparatus as in, for example, a recorder, a display apparatus 120 (such as a television set) is connected to the transmitting apparatus as shown in FIG. 1 to display reproduced contents.

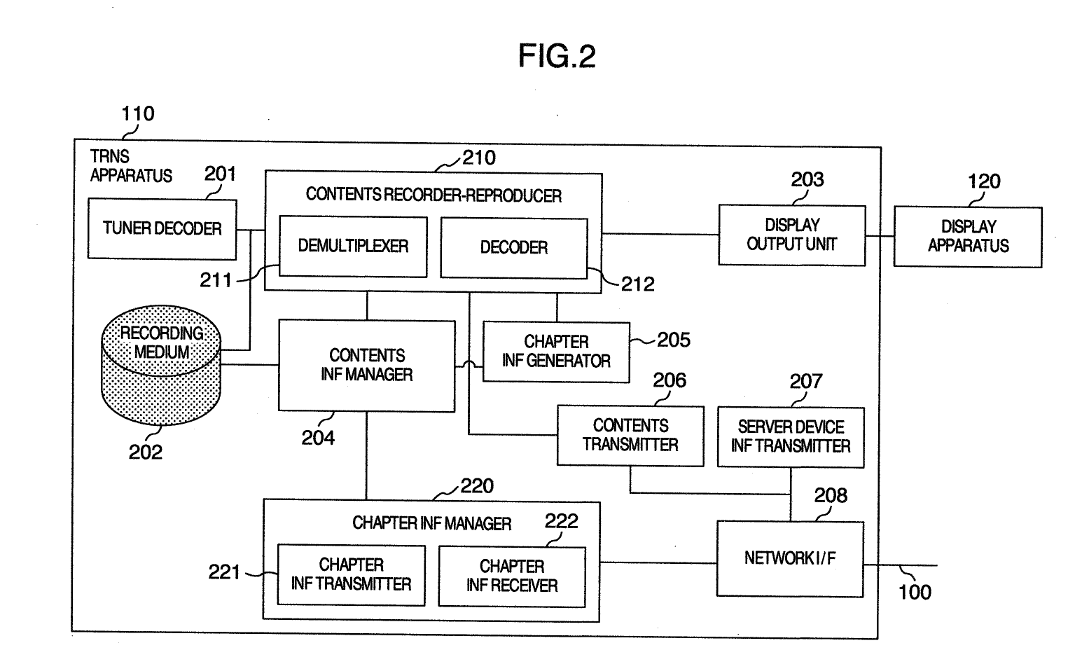

For the connection, an analog or digital interface which outputs analog or digital video data/audio data can be used. A detailed configuration example of the transmitting apparatus 110 will be described later with reference to FIG. 2.

Reference numerals 130 and 140 denote receiving apparatuses (clients) which receive moving picture, voice and image contents from the transmitting apparatus 110 on the home network 100 and reproduce the contents. The receiving apparatuses 130 and 140 are apparatuses for receiving chapter information which indicates scene partitions of the contents according to the present embodiment from the transmitting apparatus 110 and transmitting the chapter information to the transmitting apparatus 110.

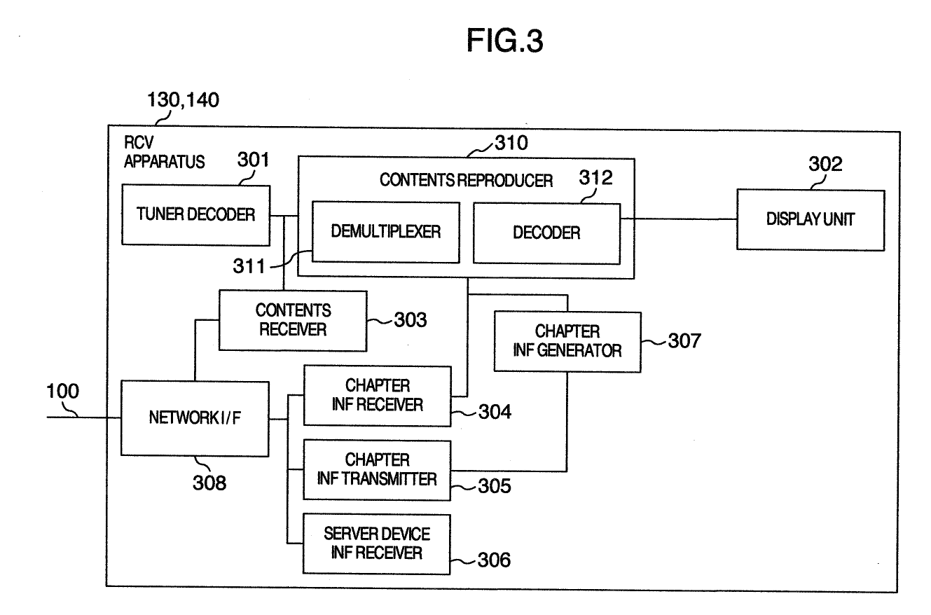

As such receiving apparatuses, for example, a television set or a personal computer (PC) is conceivable. In the case where the receiving apparatus does not contain a display apparatus as in, for example, an STB (Set Top Box), a display apparatus (such as a television set) is connected to the receiving apparatus to display reproduced contents in the same way as the transmitting apparatus 110. A detailed configuration example of the receiving apparatuses 130 and 140 will be described later with reference to FIG. 3. Although not described in the present embodiment, an apparatus having functions of both the transmitting apparatus and the receiving apparatus is also conceivable. It suffices in such an apparatus that functions (configurations and control methods) of the transmitting apparatus and the receiving apparatus described hereafter are implemented. And such a home network 100 is formed of, for example, the well-known IP (Internet Protocol) network.

A detailed configuration example of the transmitting apparatus 110 will now be described with reference to FIG. 2.

The transmitting apparatus 110 is an apparatus which receives a digital broadcast, records and reproduces contents, and transmit contents to the receiving apparatus on the home network 100. Recording of contents may be applied to contents obtained by receiving an IP broadcast via the network or downloading.

Here, the case where a signal which is coded by using the MPEG (Moving Picture Experts Group) system as the image compression technique and multiplexed by using the MPEG2-TS system is handled will be described.

A tuner decoder 201 receives a digital broadcast signal transmitted via a broadcast transmission network such as radio (satellite or terrestrial) or a cable. The tuner decoder 201 conducts station selection and decoding processing at a frequency of a channel specified by the user's instruction via a remote controller or the like. Furthermore, the tuner decoder 201 in the contents recorder outputs an MPEG2-TS (transport stream) subjected to digital demodulation and error correction processing to a demultiplexer 211 in the contents recorder-reproducer 210 via a selector which is not illustrated.

The demultiplexer 211 demultiplexes transport packets of a channel (program) specified by the user via the remote controller or the like from the MPEG2-TS which is input. When reproducing contents, a video and audio PES (Packetized Elementary Stream) or ES (Elementary Stream) is further demultiplexed from the demultiplexed transport packets and output to a decoder 212. When recording contents, time stamp information is further added and resultant packets are output to a contents information manager 204.

When reproducing contents, the decoder 212 extracts the video/audio PES or ES and decodes it, and outputs a decoded video/audio to a display output unit 203.

The display output unit 203 outputs the decoded video/audio to the external display apparatus 120 via a digital and/or an analog interface. At this time, an operation screen image such as a menu or a contents list generated in a drawer which is not illustrated and presented to the user is combined with the decoded video, and a resultant video is output.

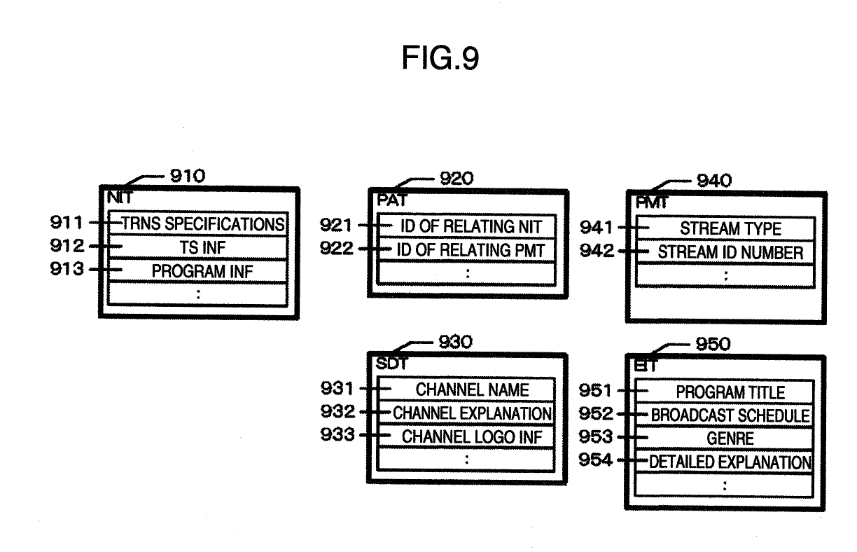

When recording contents, the demultiplexer 211 detects information such as a title, a genre and format information of a channel (program) to be recorded on a recording medium 202 from transport packets of a channel (program) specified by a user's instruction via a remote controller or the like, and outputs the detected information to the contents information manager 204. Information which indicates the title, genre, a broadcast schedule and the like is stored in, for example, PSI or SI information of an MPEG-TS. (The outline of the PSI and SI information will be described later with reference to FIG. 9).

The contents information manager 204 creates management information on the basis of the information such as the title given by the demultiplexer 211, and records the transport packets which are input from the demultiplexer 211 onto the recoding medium 202 on the basis of the management information. At this time, suitable encryption processing is conducted on the transport packets in an encryption unit which is not illustrated, and resultant transport packets are recorded.

On the other hand, when transmitting contents recorded on the recording medium 202 to the receiving apparatus 130/140 on the home network 100, first, transport packets of contents recorded in the 202 which is specified by the user's operation on a remote controller or the like are read out successively and output to a contents transmitter 206. At this time, an encryption-decryption unit which is not illustrated decrypts the contents and conducts encryption processing for outputting the contents to the home network.

The contents transmitter 206 removes the time stamp information from the transport packets decoded and added with the time stamp, and outputs resultant transport packets to a network I/F 208. Besides this, the contents transmitter 206 receives a transmitting start request or a transmitting stop request of contents from the receiving apparatus 130/140 via the network I/F 208.

The contents transmitting request is accepted by using a position where transmitting of contents is started and its length as parameters. If the contents transmitting request is received, then the contents transmitter 206 suitably exercises control of cueing specification and length specification on contents recorded on the recording medium 202, reads out transport packets in accordance with the request, and outputs the transport packets to the network I/F 208. On the other hand, if the transmitting stop request is received, then the contents transmitter 206 stops the output to the network I/F 208 and stops readout of transport packets from the recoding medium 202.

The network I/F 208 outputs the transport packets which are input from the contents transmitter 206 to the receiving apparatus 130/140 via the home network 100 while conducting conversion to a form which meets transmission standards and exercising flow control. Besides this, the network I/F 208 is used when transmitting and/or receiving information such as chapter information, server device information, or service description information which will be described later to and/or from the receiving apparatus 130/140 on the network 100.

The transmitting apparatus 110 further includes a chapter information generator 205 for generating chapter information which indicates scene partitions of contents in the recording medium 202, a server device information transmitter 207 for transmitting server device information added with information indicating that a chapter information transmitting function is included and service description information which indicates its control method, and a chapter information manager 220 for managing the chapter information which indicates scene partitions of contents in the recording medium 202.

The chapter information manager 220 includes a chapter information transmitter 221 for transmitting chapter information to the receiving apparatus 130/140 via the network I/F 208, and a chapter information receiver 222 for receiving chapter information indicating scene partitions of contents generated and updated in the receiving apparatus 130/140.

A detailed configuration example of the receiving apparatuses 130 and 140 will now be described with reference to FIG. 3. In the ensuing description, the receiving apparatus 130 is taken as an example.

The receiving apparatus 130 is an apparatus for receiving contents from a digital broadcast and the transmitting apparatus 110 on the home network 100 and reproducing the contents.

When receiving and reproducing a digital broadcast, a tuner decoder 301 receives a digital broadcast signal transmitted via a broadcast transmission network such as a radio (satellite or terrestrial) or a cable. The tuner decoder 301 conducts station selection and detection processing at a frequency of a channel specified by the user's instruction via a remote controller or the like. Furthermore, the tuner decoder 301 outputs an MPEG2-TS (transport stream) subjected to digital demodulation and error correction processing to a demultiplexer 311 in a contents reproducer 310 via a selector which is not illustrated.

The demultiplexer 311 demultiplexes transport packets of a channel (program) specified by the user's instruction via the remote controller or the like from the MPEG2-TS which is input. A video and audio PES (Packetized Elementary Stream) or ES (Elementary Stream) is further demultiplexed from the demultiplexed transport packets and output to a decoder 312.

On the other hand, when reproducing contents received from the transmitting apparatus 110 on the home network 100, first, transport packets of contents transmitted by the transmitting apparatus 110 in accordance with the user's instruction given by operating the remote controller or the like are received successively via a network I/F 308.

The network I/F 308 receives transport packets to be output to a contents receiver 303 from the transmitting apparatus 110 via the home network 100 while conducting conversion from a form which meets transmission standards and exercising flow control. Besides this, the network I/F 308 is used when transmitting and/or receiving information such as chapter information, server device information, or service description information which will be described later to and/or from the transmitting apparatus 110 on the network 100.

The transport packets received via the network I/F 308 are output to the contents receiver 303, and the output is further output to the demultiplexer 311 via a selector which is not illustrated. At this time, contents encrypted when transmitted via the network I/F are decrypted in a network transmission decryption unit which is not illustrated.

Besides this, the contents receiver 303 adds a position where transmitting of contents is to be started and a length to a transmitting start request or transmitting stop request as parameters on the basis of an instruction given by the user who operates the remote controller or the like such as cueing reproduction (chapter skip), fast feed reproduction, or temporary stop start and stop, and transmits a resultant transmitting start request or transmitting stop request to the transmitting apparatus 110 via the network I/F 308.

The demultiplexer 311 demultiplexes a video and audio PES (Packetized Elementary Stream) or ES (Elementary Stream) from the transport packets which are input from the contents receiver 303, and outputs the PES or ES stream to the decoder 312.

The decoder 312 takes out and decodes the video/audio PES or ES, and outputs the decoded video/audio to a display unit 302.

The display unit 302 displays the decoded video/audio. At this time, the display unit 302 combines an operation screen image such as a menu, a contents list, and a chapter generated in a drawer, which is not illustrated, to be presented to the user with the decoded video, and displays a resultant video.

In the present embodiment, the transmitting apparatus 110 transmits chapter information which indicates partition positions of contents to the receiving apparatus 130/140, and the receiving apparatus acquires the chapter information and exercises control (the case where the receiving apparatus generates the chapter information is also included). As for means for generating the chapter information in the transmitting apparatus 110 or the receiving apparatus 130/140, various systems are already opened to the public and consequently detailed description of the means will be omitted. However, it is possible to use, for example, a method based on a user's instruction given via input means such as the remote controller.

The receiving apparatus 130 further includes a chapter information generator 307 for generating or updating chapter information which indicates scene partitions of contents received from the transmitting apparatus 110 and reproduced, a server device information receiver 306 for receiving server device information added with information indicating that a chapter information transmitting function is included and service description information which indicates its control method via the network I/F 308, a chapter information receiver 304 for receiving chapter information from the transmitting apparatus 110, and a chapter information transmitter 305 for transmitting chapter information generated or updated in the chapter information generator 307 in the receiving apparatus 130.

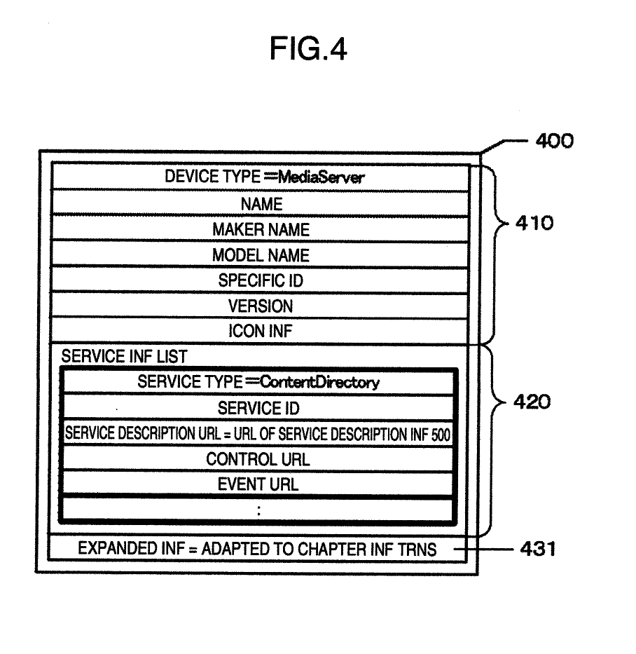

An example of server device information added with information indicating that the chapter information transmitting function is included will now be described with reference to FIG. 4. The information is transmitted (sent as a reply) by the transmitting apparatus 110 in response to a request from the receiving apparatus 130/140 and retained in the server device information transmitter 207 described with reference to FIG. 2.

When broadly divided, server device information 400 is formed of device information 410 which indicates a type and a model of a device and a service information list 420 which indicates information concerning at least one service provided by the device. The configuration itself of the server device information 400 is not a configuration specific to the transmitting apparatus (server), and a value of information included in the server device information 400 indicates that the device is the transmitting apparatus (server).

As shown in FIG. 4, the device information 410 includes “device type” which indicates the type of the device, “name,” “maker name,” “model name,” “specific ID,” “version,” and “icon information” as information of the device itself having the server device information 400. And in the case of the transmitting apparatus 110, the “device type” is described as “Media Server” as shown in FIG. 4 to indicate that the device is the transmitting apparatus (server).

The service information list 420 includes every service, “service type,” which indicates a type of the service, “service ID,” “service description URL” which indicates access destination to control details of the service, “control URL” which indicates a control destination of the service, and “event URL” which indicates a notice destination of the service.

In the present embodiment, a service which provides a contents list having a service type “Content Directory” is utilized. It is made possible for the receiving apparatus 130/140 to acquire chapter information every contents by using a control method described in service description information 500 (details thereof will be described later) which indicates control details of this service.

And the information which indicates that the chapter information transmitting function is included according to the present embodiment is described by using expanded information 431 apart from the device information 410 and the service information list 420. By doing so, it becomes possible also in a receiving apparatus which does not comply with utilization of the chapter information transmitting function to interpret the device information 410 and the service information list 420 in the server device information 400.

Furthermore, a method of describing the information which indicates that the chapter information transmitting function is included, in the device information 410 or the service information list 420 is also conceivable. In that case, a method of expressing the information which indicates that the chapter information transmitting function is included is expanded information in the device information 410 or the service information list 420 or describing the information at the end is conceivable.

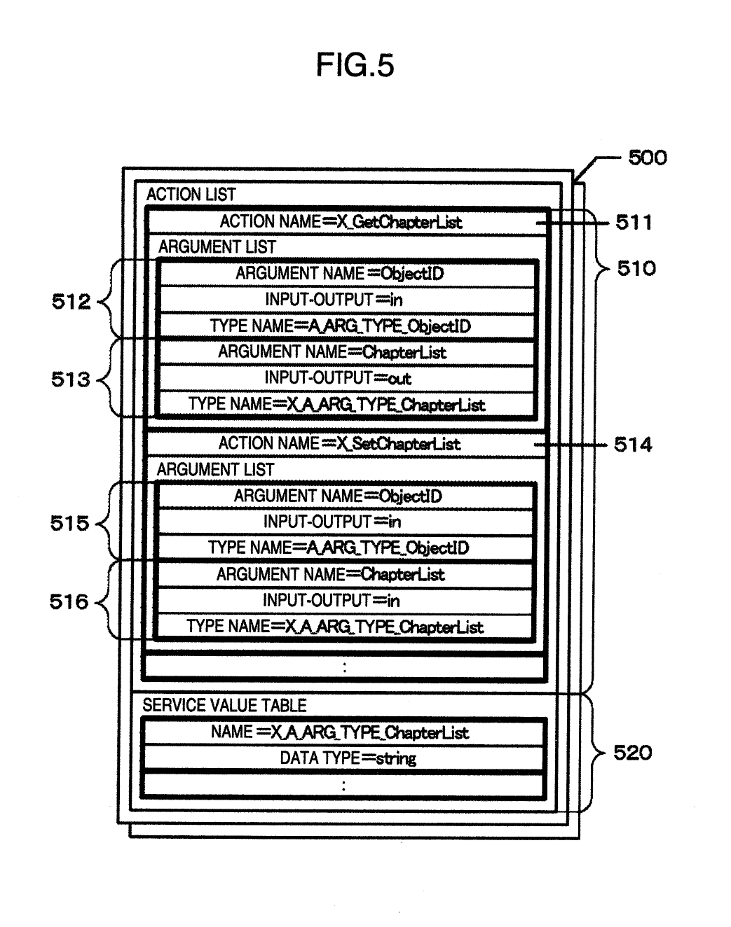

A configuration example of the service description information 500 indicating details of control of a service which is “Content Directory” in service type and provides a contents list will now be described with reference to FIG. 5. The service description information 500 is transmitted (sent as a reply) by the transmitting apparatus 110 in response to a request from the receiving apparatus 130/140 and retained in the server device information transmitter 207 described with reference to FIG. 2.

When broadly divided, the service description information 500 is formed of an action list 510 which indicates at least one action (control) method for the service and a service value table 520 which explains a type of input-output values of an action described in the action list 510. They are prepared every service.

Every action in the action list 510, an action name and an argument list used in the action are described as shown in FIG. 5. In the argument list, an argument name, an input-output direction, and a type name are described in each argument. As for actions concerning acquisition and setting of chapter information according to the present invention, actions shown in FIG. 5 are defined.

In an action indicated by an action name “X_GetChapterList” 511, the transmitting apparatus 110 sends chapter information 632 (described later) as a reply in response to an acquisition request from the receiving apparatus 130/140. Specifically, the receiving apparatus 130/140 specifies an argument indicated in an argument 512 (an argument having an argument name “ObjectID”) and issues a chapter information acquisition request to the transmitting apparatus 110.

Upon receiving this acquisition request, the transmitting apparatus 110 sets an argument indicated in an argument 513 (an argument having an argument name “ChapterList”) and sends chapter information as a reply. By the way, the argument name indicated here “Object ID” is an ID which uniquely determines contents transmitted by the transmitting apparatus 110 (details will be described later). In other words, it is an action in which the transmitting apparatus 110 sends chapter information for contents specified by the receiving apparatus 130/140 as a reply.

In an action indicated by an action name “X_SetChapterList” 514, the transmitting apparatus 110 sets (updates) chapter information 612 (described later) in response to a setting request from the receiving apparatus 130/140. Specifically, the receiving apparatus 130/140 specifies an argument indicated in an argument 515 (an argument having an argument name “ObjectID”) and an argument 516 (an argument having an argument name “ChapterList”), and issues a chapter information setting request to the transmitting apparatus 110.

Upon receiving this setting request, the transmitting apparatus 110 sets (updates) the chapter information 632 (described later) or expanded chapter information 642 corresponding to contents indicated in “ObjectID” in the argument 515 by using “ChapterList” indicated in the argument 516. In other words, it is an action in which the transmitting apparatus 110 sets (updates) chapter information for contents specified by the receiving apparatus 130/140.

As described earlier, the service value table 520 is a table which explains the type of the input-output value of the action. As shown in FIG. 5, “name” (corresponding to a type name in the action list 510) and “data type” of the type (character string, sign-less 4-byte integer type or the like) are described in each type.

In the “X_GetChapterList” action and the “X_SetChapterList” action described above, a type having a name “X_A_ARG_TYPE_ChapterList” is used as shown in FIG. 5. As a result, the type is described (a data type having a character string “string” is described). In other words, the argument “ChapterList” is represented by a character string (in the present embodiment, it is supposed that the configuration of chapter information represented by a character string assumes a configuration of chapter information 1000 described later).

It becomes possible for the receiving apparatus 130/140 to obtain chapter information acquisition and setting means by referring to the server device information 400 and the service description information 500 described heretofore. By the way, names described here have been used as examples, and names are not restricted to the names described here.

A configuration example of a table for managing in the transmitting apparatus 110 contents recorded in the recording medium 202, contents transmitted to the receiving apparatus 130/140, and chapter information which indicates scene partitions of contents will now be described.

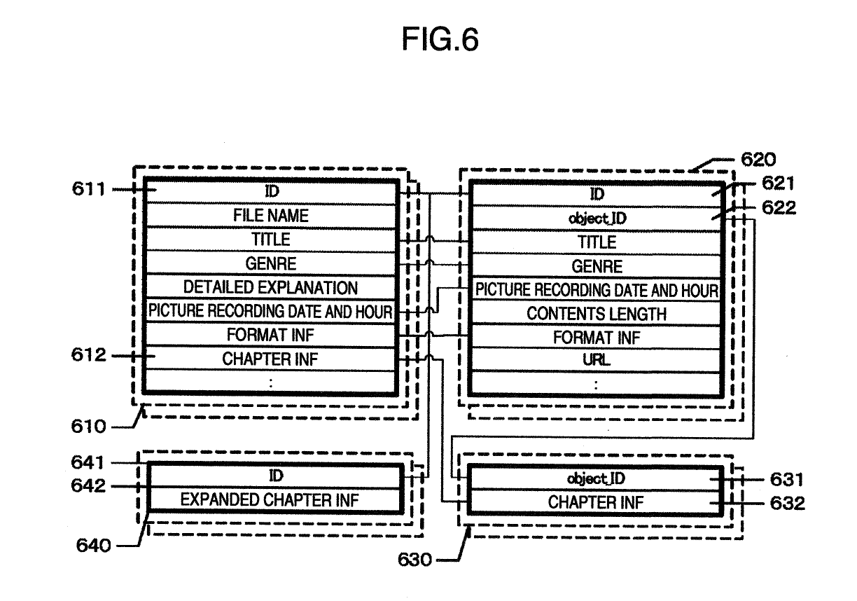

In FIG. 6, intra recording medium contents information 610 is a table for managing information of contents recorded in the recording medium 202, network delivery contents information 620 is a table for managing contents transmitted to the receiving apparatus 130/140, and chapter information 630 is a table for managing chapter information which indicates scene partitions of contents between the transmission apparatus 110 and the receiving apparatus 130/140.

In addition, expanded chapter information 640 is a table for managing chapter information which indicates scene partitions of contents in an expanded manner as a table which is different from that of the intra recoding medium contents information 610. The expanded chapter information 640 is used, for example, in the case where significance is given to chapter information in dependence on a genre of contents and chapter information is managed as a plurality of chapter lists (for example, in the case where a chapter list for weather scene and a chapter list for sports scene are provided in a news program) or in the case where an operation of each chapter is defined and chapter information is managed (for example, in the case where an automatic skip operation is defined for a part of contents not to be viewed).

The intra recording medium contents information 610 includes an ID 611 which uniquely determines contents, chapter information 612 which indicates scene partitions of contents, a file name, a title, a genre, detailed explanation, picture recording date and hour, and format information. They are prepared every contents.

The chapter information 612 might differ in its representation method according to the kind and recording format of the recording medium 202. For example, the number of chapters included in the contents is retained. And a chapter number, and a packet position or a byte position from the head of contents which indicates the position of the chapter, or a chapter position represented by time are retained in each chapter. And the intra recording medium contents information 610 is retained in the contents information manager 204 (or the recording medium 202) described with reference to FIG. 2.

The expanded chapter information 640 includes an ID 641 which is an ID for uniquely determining contents in the intra recording medium contents information 610, and expanded chapter information 642 which expands the chapter information 612 in the intra recording medium contents information 610. They are prepared every contents.

The expanded chapter information 642 has a configuration similar to that of the chapter information 612 in the intra recording medium contents information 610. As described earlier, the expanded chapter information 642 includes at least one chapter list, and a name and a type are retained in each chapter list. In addition, a chapter type is retained in each chapter. And the expanded chapter information 640 is retained in the contents information manager 204 (or the recording medium 202) described with reference to FIG. 2.

The network delivery contents information 620 includes an ID 621 which is an ID for uniquely determining contents in the intra recording medium contents information 610 (which assumes the same value as the ID 611 in the present embodiment), an object_ID 622 for uniquely determining contents to be transmitted to the receiving apparatus 130 and 140, a title, a genre, picture recording date and hour, a contents length, format information, and a URL. They are prepared every contents.

Here, the title, genre, picture recording data and hour, and format information are prepared in a form overlapping the intra recording medium contents information 610. However, it is not always necessary to prepare them in the network delivery contents information 620. In the case where they are not prepared in the network delivery contents information 620, corresponding information in the intra recording medium contents information 610 should be read out from the ID 621. And the network delivery contents information 620 is retained in the contents information manager 204 (or the recording medium 202) described with reference to FIG. 2.

The chapter information 630 is formed of an object_ID 631 which is an ID for uniquely determining contents in the network delivery contents information 620 (which assumes the same value as the ID 611 in the present embodiment), and the chapter information 632 which indicates scene partitions of contents corresponding to the object_ID 631.

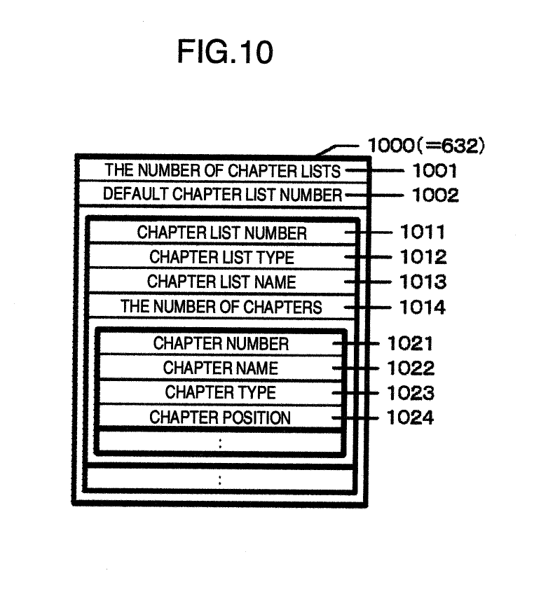

The configuration of the chapter information 632 will now be described in more detail with reference to FIG. 10. The chapter information 1000 (which means the chapter information 632) has a configuration similar to that of the argument “ChapterList” described earlier. The chapter information 1000 is formed of at least one chapter list. The chapter information 1000 includes “the number of chapter lists” 1001 which indicates the number of chapter lists and “default chapter list number” 1002 which specifies a chapter list to be displayed, for example, at the beginning. In each chapter list, “chapter list number” 1011, “chapter list type” 1012, “chapter list name” 1013, and “the number of chapters” 1014 which indicates the number of chapters included in the chapter list are retained. In addition, in each chapter, “chapter number” 1021 in the chapter list, “chapter name” 1022, “chapter type” 1023, and “chapter position” 1024 are retained. The chapter information 630 is retained in the contents information manager 204 described with reference to FIG. 2.

In the configuration of the chapter information 632 (i.e., in the configuration of the argument “ChapterList” as well), the information such as the name and type is included in each of the chapter list and chapter. In some cases, however, a simple configuration obtained by omitting them may be used. For example, a configuration in which each channel list describes only the chapter list name 1013 and the chapter position 1024 included in the chapter list may be used. As for the configuration of the argument “ChapterList,” the configuration needs to be a configuration in which the transmitting apparatus 110 and the receiving apparatus 130/140 can interpret each other. In some cases, therefore, it is conceivable to add format information which indicates the configuration of the argument “ChapterList.”

An outline of PSI and SI information in which the title, genre, broadcast schedule and the like extracted from transport packets when recording contents and retained in the intra recording medium contents information 610 by the transmitting apparatus 110 are stored will now be described with reference to FIG. 9.

As for contents multiplexed by using MPEG-TS, for example, in broadcasting, at least one transport stream is transmitted in each frequency band by using the frequency division system or the like. And at least one content (program) formed of a video, an audio and data is multiplexed on each transport stream and transmitted.

In a NIT (Network Information Table) 910 shown in FIG. 9, mainly “transmission specifications” 911 which stores frequency information and the like for receiving a desired program from a broadcasting radio wave, “TS (transport stream)” information” 912 such as a transmission classification of a transport stream corresponding to the transmission specifications, and “program information” 913 including information of a channel number corresponding to the transmission specifications and the like are stored.

In a PAT (Program Association Table) 920, an identification ID 921 for the NIT 910 included in the transport stream and an identification ID 922 for a PMT 940 described later are stored in each channel (program).

In an SDT (Service Description Table) 930, “channel name” 931 of a channel contained in the transport stream, “channel explanation” 932, “channel logo information” 933 such as link information to logo data of the channel, and the like are stored in each channel.

In a PMT (Program Map Table) 940, “stream type” 941 (which identifies digital television service, digital radio audio service, and the like), “stream identification number” 942 for identifying actual data in which the stream is stored, and the like are stored in each stream.

In an EIT (Event Information Table) 950, “program title” 951, “broadcast schedule” 952 which indicates start time and end time of the program, “genre” 953 for identifying a genre of the program, “detailed explanation” 954 which indicates an explanatory note of the program, and the like are stored in each channel. And IDs (not illustrated) which uniquely determine corresponding transport streams, channels, and programs are stored in these tables and associated with each other.

And the transmitting apparatus 110 extracts a title, a genre, a broadcast schedule, and the like which correspond to contents (program) to be recorded into the recording medium 202 from these kinds of information, and retains them in the intra recording medium contents information 610.

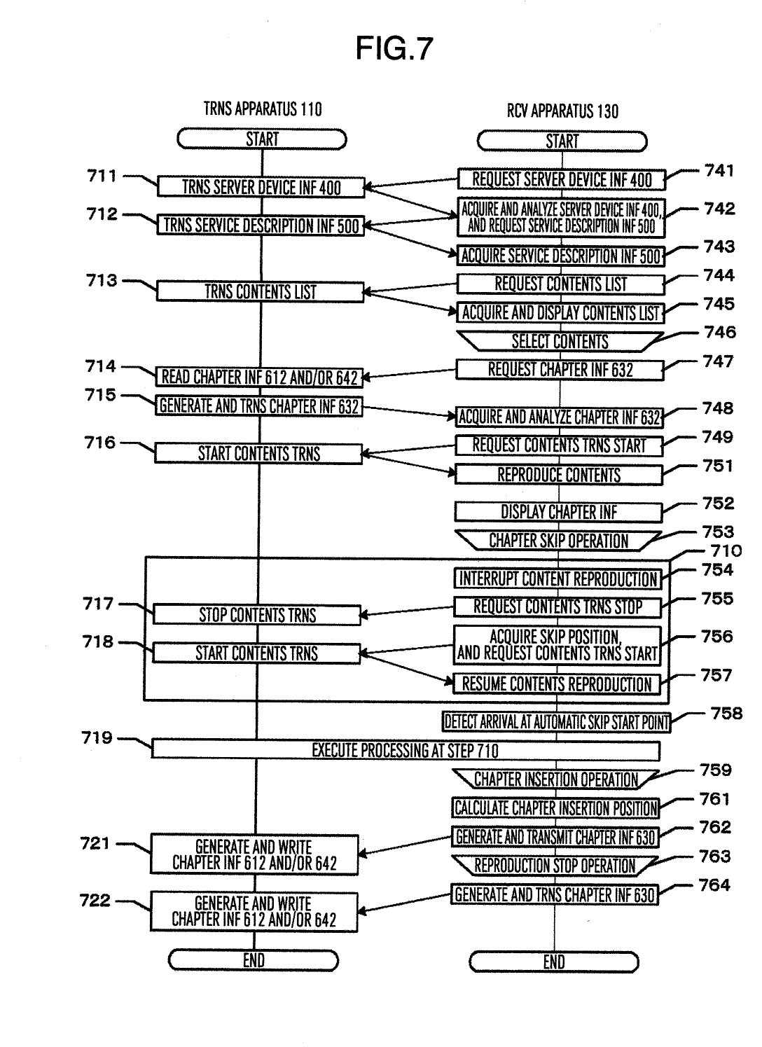

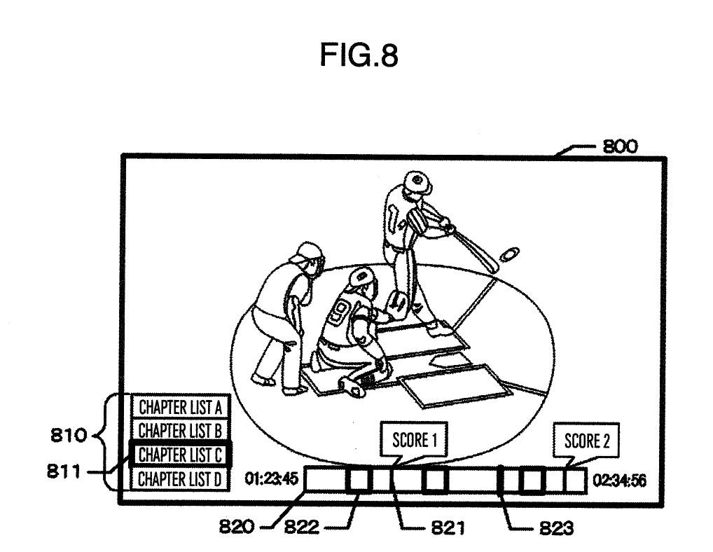

An example of a method which makes it possible for the transmitting apparatus 110 and the receiving apparatus 130 and 140 to exchange chapter information with each other in the home network 100 by using the server device information 400, the service description information 500, the intra recording medium contents information 610, the network delivery contents information 620, the chapter information 630 and the expanded chapter information 640 will now be described with reference to FIG. 7 which shows its flow chart and FIG. 8 which shows an operation screen presented to the user.

In the flow chart shown in FIG. 7, a case where the receiving apparatus 130 receives contents recorded in the recording medium 202 in the transmitting apparatus 110 (chapter information of which is already generated) (via the home network 100), reproduces the contents, presents the chapter information of the contents to the user, and conducts chapter skip and a case where chapter skip is conducted automatically without user's operation are shown as an example.

In addition, a case where thereafter the receiving apparatus 130 updates the chapter information (a case where the receiving apparatus 130 inserts a chapter and a case where the receiving apparatus 130 updates a default chapter list) and sets the chapter information in the transmitting apparatus 110 by using the function is shown as an example.

First, the user instructs the receiving apparatus 130 to conduct a list display operation of contents opened to the public on the home network 100 in order to reproduce contents recorded in the recording medium 202 in the transmitting apparatus 110 (this step is not illustrated).

Upon receiving this instruction, the receiving apparatus 130 first requests the server device information 400 from a device on the home network 100 by using the server device information receiver 306 (this request is issued to the transmitting apparatus 110 as well) (step 741).

Upon receiving this request, the transmitting apparatus 110 reads out the server device information 400 by using the server device information transmitter 207, and transmits (sends as a reply) the server device information 400 to the receiving apparatus 130 (step 711). The receiving apparatus 130 receives the server device information 400 by using the server device information receiver 306, interprets the configuration described in the explanation of FIG. 4, and requests the service description information 500 (step 742). The receiving apparatus 130 knows that the transmitting apparatus 110 complies with the function of transmitting and setting chapter information by interpreting the chapter information transmitting complying information 431 in the server device information 400 at the step 742.

Then, upon receiving the request for the service description information 500, the transmitting apparatus 110 reads out the service description information 500 by using the server device information transmitter 207, and transmits (sends as a reply) the service description information 500 to the receiving apparatus 130 (step 712).

The receiving apparatus 130 receives the service description information 500 by using the server device information receiver 306, and interprets the configuration described in the explanation of FIG. 5 (step 743). The receiving apparatus 130 can know a method for transmitting and setting chapter information to the transmitting apparatus 110 by interpreting the action list 510 and the service value table 520 in the service description information 500.

Then, the receiving apparatus 130 issues a contents list information request to the transmitting apparatus 110 in order to display a list of contents (step 744). This is conducted on the basis of a method described in the action list 510 and the service value table 520 in the service description information 500.

Upon receiving the request for the contents list information, the transmitting apparatus 110 refers to the network delivery contents information 620, and transmits (sends as a reply) information meeting the request issued by the receiving apparatus 130 (step 713). And the receiving apparatus 130 receives the contents list information, and displays a contents list by using the information (step 745). At this step, a drawer which is not illustrated generates a drawing image for list display and outputs the drawing image to the display unit 302.

Then, the user selects desired contents from the displayed contents list, and issues a reproduction instruction (step 746).

Upon receiving the reproduction instruction, the receiving apparatus 130 then issues an (acquisition) request for the chapter information 632 of the pertinent contents to the transmitting apparatus 110 by using the chapter information receiver 304 (step 747). This is conducted according to the method described in the action list 510 (by using the action name 511 and the arguments 512 and 513).

Upon receiving the (acquisition) request for the chapter information 632, the transmitting apparatus 110 reads out chapter information described in the chapter information 612 and/or the expanded chapter information 642 of the pertinent contents by following the network delivery content information 620, the intra recording medium contents information 610, and the expanded chapter information 640 on the basis of the value of ObjectID described in the argument 512 (step 714).

As occasion demands, the transmitting apparatus 110 converts values of the chapter information 612 and/or the expanded chapter information 642 into a form of the chapter information 632, generates the chapter information 632, and transmits (sends as a reply) the chapter information 632 to the receiving apparatus 130 (step 715). Then, the receiving apparatus 130 receives the chapter information 632 by using the chapter information receiver 304, and analyzes the chapter information (step 748).

Then, the receiving apparatus 130 issues a contents transmitting start request to the transmitting apparatus 110 by using the contents receiver 303 (step 749). The transmitting apparatus 110 transmits contents data by using the contents transmitter 206 in response to the contents transmitting start request issued at the step 749 (step 716). The receiving apparatus 130 receives the contents data successively by using the contents receiver 303, and reproduces the contents by using the contents reproducer 310 (step 751).

If the reproduction position of the contents is a chapter to be automatically skipped at this time, then the receiving apparatus 130 monitors the reproduction position of the contents in order to skip the reproduction of the pertinent chapter. Specifically, the receiving apparatus 130 first acquires a start point of the chapter to be automatically skipped from the chapter position 1024 on the basis of a result of the analysis conducted at the step 748. Then, the receiving apparatus 130 monitors to determine whether the reproduction position of the contents has arrived at the pertinent chapter position 1024.

Here, the user issues an instruction of chapter information display request in order to conduct a chapter operation (the present step is not illustrated). Upon receiving this instruction, the receiving apparatus 130 presents an operation screen for conducting the chapter operation (step 752). At the present step, the receiving apparatus 130 refers to the default chapter list number 1002 in the chapter information 1000 (=the chapter information 632), and displays chapter information concerning the pertinent chapter list.

In the case where chapter information is displayed and erased once and then chapter information is displayed again, a method of storing a chapter list number of a chapter list displayed lastly when erasing display of chapter information and using the stored chapter list number instead of the default chapter list number 1002 at the time of redisplay is also conceivable.

This operation screen is provided to, for example, conduct an operation for skipping a chapter and conduct an operation for selecting a certain chapter list when there are a plurality of chapter lists. This operation screen assumes a configuration as shown in FIG. 8. In FIG. 8, reference numeral 800 denotes a chapter operation screen. When broadly divided, the chapter operation screen is formed of a chapter list display part 810 and a chapter display part 820.

In a state shown in FIG. 8, a chapter list C811 is selected, and chapter information in the chapter list is shown in a time axis form and the reproduction position at the present time point is represented by a FIG. 823 and a time character string. If, for example, the user selects a chapter list different from the chapter list C811 is selected at this time, chapter information in the chapter list is re-drawn.

In the chapter list display part 810, a chapter list described in the chapter information 1000 is displayed by using information in the chapter list number 1011 or the chapter list name 1012.

In the chapter display part 820, display concerning a chapter which relates to the chapter list 811 is conducted by using information of the chapter number 1021, the chapter name 1022, the chapter type 1023, and the chapter position 1024. By the way, when displaying the position of each chapter in a time axis form, calculation is conducted by using information of a contents length contained in the contents list information acquired at the step 745 and the chapter position 1024.

As for the chapter type, there is, for example, a chapter type defined as a position (start point) where an automatic skip operation is conducted on a part of contents to be not viewed. A chapter of such a chapter type is displayed in distinction from other chapters (such as a FIG. 821) as represented by a FIG. 822.

If the user issues an instruction to skip the contents reproduction to a start point of the next chapter (step 753), then the receiving apparatus 130 executes a series of processing shown as step 710 in order to conduct skip reproduction.

First, in the step 710, the receiving apparatus 130 interrupts the reproduction of the contents (step 754) and requests the transmitting apparatus 110 to stop the transmitting of the contents (step 755). Upon receiving the transmitting stop request, the transmitting apparatus 110 stops transmitting of the pertinent contents (step 717). Thereafter, the receiving apparatus 130 acquires the chapter position 1024 of a chapter disposed immediately after the reproduction position in time, on the basis of the reproduction position of contents at time when the user has issued the skip instruction. And the receiving apparatus 130 requests the transmitting apparatus 110 to start transmitting of contents by specifying a transmitting start position on the basis of position information of contents indicated in the chapter position (step 756). The transmitting apparatus 110 transmits contents data by using the contents transmitter 206 in response to the contents transmitting start request issued at the step 756 (step 718), and the receiving apparatus 130 resumes the reproduction of the contents in the same way as the step 751 (step 757).

If the contents reproduction position has arrived at a part of the contents which is not to be viewed described with reference to FIG. 8, the receiving apparatus 130 detects arrival at the start point of the chapter monitored beforehand (step 758) and then executes a series of processing in the step 710 described above (step 719).

If the user instructs to insert a chapter in a certain position of the contents (by operating on a screen as shown in FIG. 8 or operating a chapter insertion button assigned to a remote controller) (step 759), then the receiving apparatus 130 first calculates the insertion position instructed by the user (step 761).

And the receiving apparatus 130 generates the chapter information 630 and transmits it to the transmitting apparatus 110 in order to set the calculated information in the transmitting apparatus 110 (step 762). This is conducted according to a method described in the action list 510 (by using the action name 514 and the arguments 515 and 516).

Upon receiving the (setting) request for the chapter information 630, the transmitting apparatus 110 generates and writes chapter information 612 and/or 642 of the pertinent contents on the basis of a value of ChapterList described in the argument 516 by following the network delivery contents information 620, the intra recording medium contents information 610, and the expanded chapter information 640 on the basis of the value of ObjectID described in the argument 512 (step 721).

If the user stops the reproduction of the contents (step 763), then the receiving apparatus 130 first compares the default chapter list number 1002 in the chapter information 632 (=the chapter information 1000) received from the transmitting apparatus 110 with a number of a chapter list selected lastly by the user (the present step is not illustrated).

If there is a difference as a result of the comparison, then the receiving apparatus 130 generates (updates) the chapter information 630 and transmits it to the transmitting apparatus 110 in the same way as the step 762 (step 764). Finally, upon receiving the (setting) request for the chapter information 630, the transmitting apparatus 110 updates the chapter information 612 and/or 642 in the same way as the step 721 (step 722).

By doing as described heretofore, not only the receiving apparatus (client) can acquire chapter configuration information from the transmitting apparatus (server), but also it becomes possible for the receiving apparatus (client) to cause the server to set chapter configuration information which is set (inserted or updated) by the client. In addition, it becomes possible for the receiving apparatus (client) to manage the chapter information of contents solely on the home network.

Furthermore, even in the case where the configuration of the chapters is formed of a plurality of chapter lists according to the significance to chapters, it becomes possible for the server and the client to acquire its configuration information from each other. Its configuration information has a common configuration which does not depend upon the recording medium, and the server is configured to convert chapter configuration information which depends upon the recording medium to this common configuration. As a result, it becomes possible for the client to interpret the chapter information without being conscious of (the recording medium in) the server.

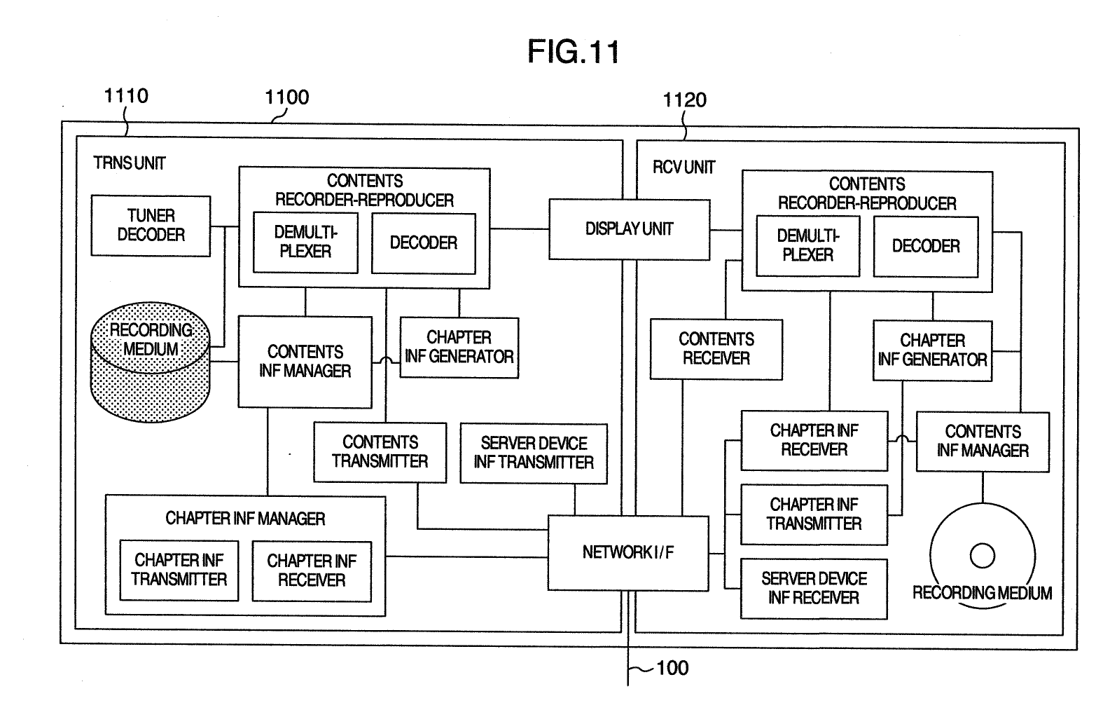

By the way, the present embodiment can be also applied to a case where in an apparatus including a plurality of recording media, configurations of the transmitting apparatus 110 and the receiving apparatus 130/140 described heretofore are formed in one apparatus respectively as a transmitting unit and a receiving unit. In this case, the transmitting unit and the receiving unit are connected to each other by a network I/F and the display unit receives signals from both the transmitting unit and the receiving unit as shown in, for example, FIG. 11.

By doing so, it becomes possible to deliver chapter information to each other even in the case where the managing method of chapter information differs in the recording media and it becomes possible to make processing common when delivering chapter information with an external transmitting apparatus or receiving apparatus connected to the home network 100.

The embodiment has been described by taking the case where the receiving apparatus (client) acquires list information of contents and chapter configuration information from the transmitting apparatus (server) and the server is caused to set chapter configuration information which is set (inserted or updated) in the client as an example. However, a configuration in which a control apparatus different from the client acquires list information of contents and chapter configuration information from the server is also possible. As a result, it becomes possible to conduct an operation concerning the contents selection or a chapter from a terminal at hand such as a PC (personal computer) or a tablet terminal. Hereafter, processing in this case will be described.

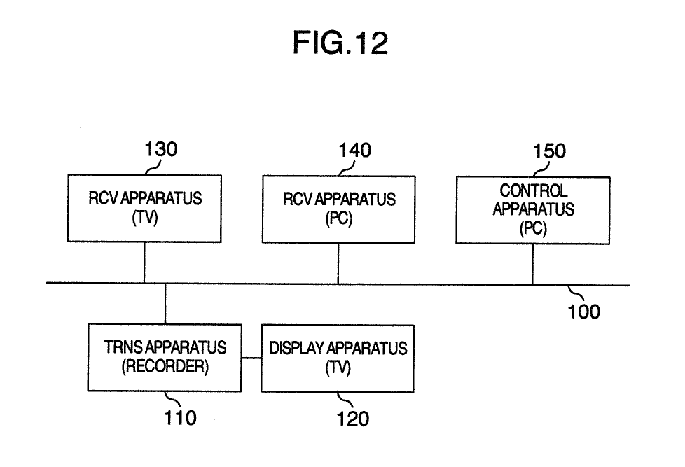

FIG. 12 shows a configuration example in a case where a control apparatus 150 (such as a PC (personal computer)) is further connected on the home network 100 shown in FIG. 1.

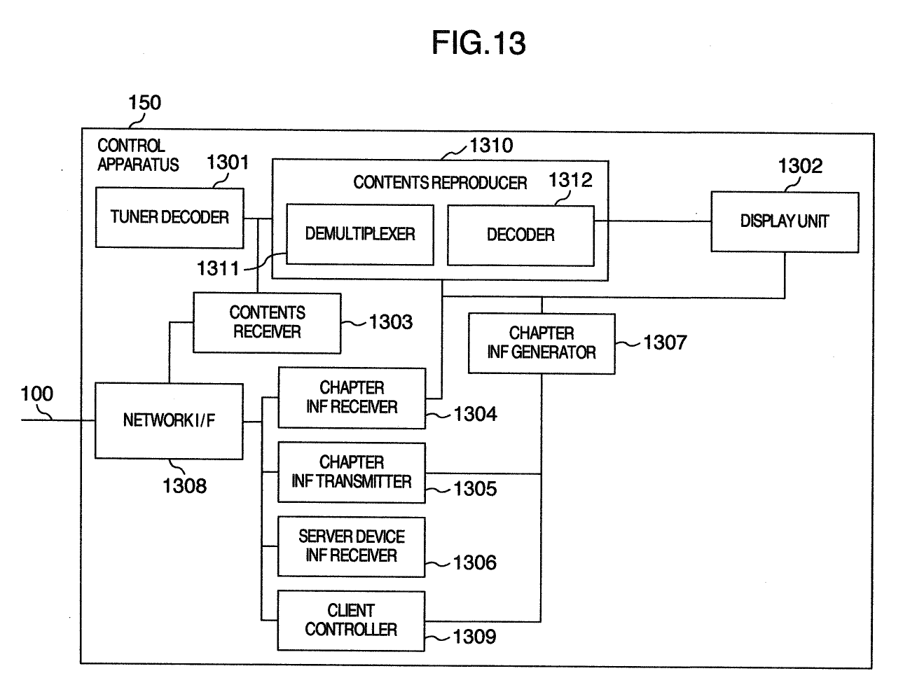

The control apparatus 150 is an apparatus which receives contents list information and chapter information which indicates scene partitions of contents. In addition, the control apparatus 150 controls the receiving apparatus 130/140, and issues an instruction for contents reproduction and stop and scene cueing based on received chapter information. As such a control apparatus, for example, a PC (personal computer), a portable telephone, a tablet terminal, or the like is conceivable. By the way, a detailed configuration example of the control apparatus 150 will be described later with reference to FIG. 13.

In the description with reference to FIG. 1, an example in which the receiving apparatus 130 and 140 receive chapter information directly from the transmitting apparatus 110 and transmit chapter information directly to the transmitting apparatus 110 is shown. Here, however, they are not indispensable, but it is also made possible for the receiving apparatus 130 and 140 to separately receive an instruction from the control apparatus 150 and receive contents from the transmitting apparatus 110 and reproduce the contents. Although not illustrated, therefore, a detailed configuration example of the receiving apparatuses 130 and 140 has a controller added to the configuration shown in FIG. 3 in order to receive a contents control instruction from the control apparatus 150.

A detailed configuration example of the control apparatus 150 will now be described with reference to FIG. 13.

The control apparatus 150 is an apparatus which receives contents list information from the transmitting apparatus 110 on the home network 100 and displays the contents list information, and instructs the receiving apparatus 130 and 140 to conduct or stop reproduction on the basis of a contents control instruction given by a user's operation.

A tuner decoder 1301, a demultiplexer 1311, a decoder 1312, and a contents receiver 1303 shown in FIG. 13 are used when the control apparatus 150 itself receives and reproduces a digital broadcast signal from a broadcasting transmission network or transport packets from the transmitting apparatus 110 in the same way as the receiving apparatus 130 and 140. Its control method is the same as that described with reference to FIG. 3.

A network I/F 1308 is used when the control apparatus 150 transmits information such as chapter information, server device information or service description information to the transmitting apparatus 110 on the home network 100 or the control apparatus 150 receives such information from the transmitting apparatus 110, and when the control apparatus 150 instructs the receiving apparatus 130/140 to conduct or stop reproduction on the basis of a contents control instruction given by an operation of the user.

A display unit 1302 displays an operation screen image such as a menu, a contents list or a chapter generated by a drawer which is not illustrated and presented to the user.

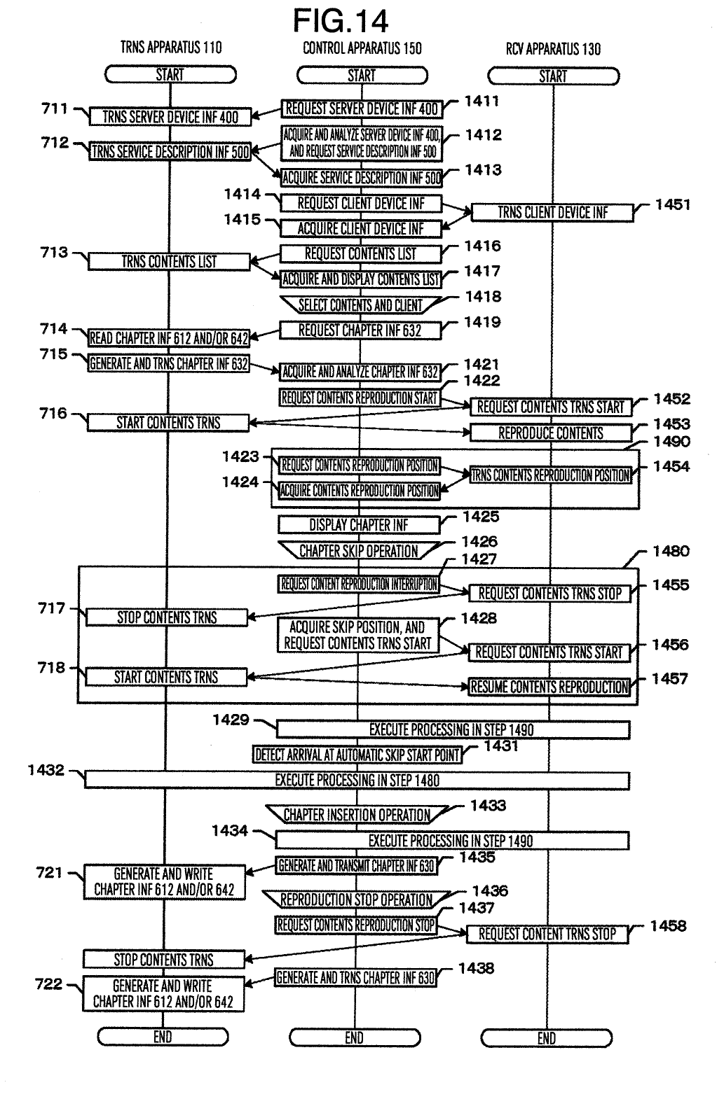

An example of a method for exchanging chapter information with each other in the home network 100 via the control apparatus 150 will now be described with reference to FIG. 14 showing its flow chart.

In the flow chart shown in FIG. 14, a case where the control apparatus 150 receives information concerning contents recorded in the recording medium 202 in the transmitting apparatus 110 (chapter information of which is already generated) (via the home network 100), presents the chapter information of the contents to the user, and conducts chapter skip by controlling the receiving apparatus 130, and a case where chapter skip is conducted automatically without user's operation are shown as an example.

In addition, a case where thereafter the control apparatus 150 updates the chapter information (a case where the control apparatus 150 inserts a chapter and a case where the control apparatus 150 updates a default chapter list) and sets the chapter information in the transmitting apparatus 110 by using the function is shown as an example. In FIG. 14, steps 711 to 718, 721 and 722 executed by the transmitting apparatus 110 are steps of exercising the same control as that at those steps shown in FIG. 7 except that the opposite party of transmitting and receiving of various kinds of information becomes the control apparatus in some cases.

First, in the control apparatus 150, the user instructs the control apparatus 150 to conduct a list display operation of contents opened to the public on the home network 100 in order to conduct list display of contents recorded in the recording medium 202 in the transmitting apparatus 110 (this step is not illustrated).

Upon receiving this instruction, the control apparatus 150 first requests the server device information 400 from a device on the home network 100 by using a server device information receiver 1306 (this request is issued to the transmitting apparatus 110 as well) (step 1411).

Upon receiving this request, the transmitting apparatus 110 reads out the server device information 400 by using the server device information transmitter 207, and transmits (sends as a reply) the server device information 400 to the control apparatus 150 (step 711). The control apparatus 150 receives the server device information 400 by using the server device information receiver 1306, interprets the configuration described in the explanation of FIG. 4, and requests the service description information 500 (step 1412).

The control apparatus 150 knows that the transmitting apparatus 110 complies with the function of transmitting and setting chapter information by interpreting the chapter information transmitting complying information 431 in the server device information 400 at the step 1412.

Then, upon receiving the request for the service description information 500, the transmitting apparatus 110 reads out the service description information 500 by using the server device information transmitter 207, and transmits (sends as a reply) the service description information 500 to the control apparatus 150 (step 712).

The control apparatus 150 receives the service description information 500 by using the server device information receiver 1306, and interprets the configuration described in the explanation of FIG. 5 (step 1413). The control apparatus 150 can know a method for transmitting and setting chapter information to the transmitting apparatus 110 by interpreting the action list 510 and the service value table 520 in the service description information 500.

Then, the control apparatus 150 requests client device information for causing the user to select a device which reproduces contents (step 1414). This is conducted by a client controller 1309, and the request is transmitted to devices on the home network 100 (the request is issued to the receiving apparatus 130 and 140 as well).

A receiving apparatus having a function of reproducing contents in response to an instruction from the control apparatus transmits (send as a reply) a signal indicating that the receiving apparatus has the pertinent function to the control apparatus 150 as the client device information by using a client device information transmitter which is not illustrated (step 1451) (in the present example, the receiving apparatus 130 has the pertinent function). Upon receiving the client device information, the control apparatus 150 knows that the receiving apparatus 130 complies with the function of reproducing contents in response to an instruction from the control apparatus, on the basis of the client device information (step 1415).

Then, the control apparatus 150 issues a contents list information request to the transmitting apparatus 110 in order to display a list of contents (step 1416). This is conducted on the basis of a method described in the action list 510 and the service value table 520 in the service description information 500.

Upon receiving the request for the contents list information, the transmitting apparatus 110 refers to the network delivery contents information 620, and transmits (sends as a reply) information meeting the request issued by the control apparatus 150 (step 713). And the control apparatus 150 receives the contents list information, and displays a contents list by using the information (step 1417).

At this time, the control apparatus 150 displays a list of receiving apparatuses which conduct reproduction of the pertinent contents on the basis of the client device information acquired at the step 1415 (this may be conducted before or after the user selects desired contents). Furthermore, at this step, a drawer which is not illustrated generates a drawing image for list display and outputs the drawing image to the display unit 1302.

Then, the user selects desired contents and a receiving apparatus from the displayed contents list and receiving apparatus list, and issues a reproduction instruction (step 1418).

Upon receiving the reproduction instruction, the control apparatus 150 then issues an (acquisition) request for the chapter information 632 of the pertinent contents to the transmitting apparatus 110 by using a chapter information receiver 1304 (step 1419). This is conducted according to the method described in the action list 510 (by using the action name 511 and the arguments 512 and 513).

Upon receiving the (acquisition) request for the chapter information 632, the transmitting apparatus 110 reads out chapter information described in the chapter information 612 and/or the expanded chapter information 642 of the pertinent contents by following the network delivery content information 620, the intra recording medium contents information 610, and the expanded chapter information 640 on the basis of the value of ObjectID described in the argument 512 (step 714).

As occasion demands, the transmitting apparatus 110 converts values of the chapter information 612 and/or the expanded chapter information 642 into a form of the chapter information 632, generates the chapter information 632, and transmits (sends as a reply) the chapter information 632 to the control apparatus 150 (step 715). Then, the control apparatus 150 receives the chapter information 632 by using the chapter information receiver 1304, and analyzes the chapter information (step 1421).

Then, the control apparatus 150 issues a contents reproduction start request to the receiving apparatus 130 by suing the client controller 1309 (step 1422). Upon receiving this request, the receiving apparatus 130 issues a contents transmitting start request to the transmitting apparatus 110 by suing the contents receiver 303 (step 1452).

The transmitting apparatus 110 conducts transmitting of contents data by using the contents transmitter 206 in response to the contents transmitting start request issued at the step 1452 (step 716). The receiving apparatus 130 receives the contents data successively by using the contents receiver 303, and reproduces the contents by using the contents reproducer 310 (step 1453).

Here, the user issues an instruction of chapter information display request in order to conduct a chapter operation (the present step is not illustrated). Upon receiving this instruction, the control apparatus 150 requests information of the contents reproduction position from the receiving apparatus 130 in order to display the position of contents which are being reproduced by the receiving apparatus 130 at that time point on an operation screen for conducting a chapter operation (step 1423). Upon receiving this request, the receiving apparatus 130 calculates the reproduction position of the pertinent contents, and transmits (sends as a reply) the obtained reproduction position to the control apparatus 150 (step 1454).

And the control apparatus 130 receives this (step 1424), and presents an operation screen for conducting the chapter operation (step 1425). At the present step, the control apparatus 150 refers to the default chapter list number 1002 in the chapter information 1000 (=the chapter information 632), and displays chapter information concerning the pertinent chapter list. The displayed operation screen is the same as that shown in FIG. 1 (however, superposition on contents which are being reproduced by the receiving apparatus is not needed). When displaying the position of each chapter in a time axis form, calculation is conducted by using information of a contents length contained in the contents list information acquired at the step 1417 and the chapter position 1024.

A series of steps 1490 formed of the steps 1423, 1454 and 1424 are conducted as occasion demands when the control apparatus 150 uses information of the contents reproduction position in the receiving apparatus. Besides when displaying the chapter information, when the reproduction position of the pertinent contents is in a chapter to be automatically skipped, the series of steps 1490 are conducted at predetermined intervals (for example, at intervals of one second) in order to monitor the reproduction position of the pertinent contents and skip the reproduction of the pertinent chapter.

And the control apparatus 150 acquires the start point of the chapter to be automatically skipped, from the chapter position 1024 on the basis of a result obtained by the analysis conducted at the step 1421. Then, the control apparatus 150 monitors whether the reproduction position of the pertinent contents has arrived at the pertinent chapter position 1024. In addition, it is also possible to correct the predetermined interval by using time information of a clock which is not illustrated and which is included in the control apparatus 150 while executing the processing at the steps 1490 at the predetermined interval.

In the case where chapter information is displayed and erased once and then chapter information is displayed again, a method of storing a chapter list number of a chapter list displayed lastly when erasing display of chapter information and using the stored chapter list number instead of the default chapter list number 1002 at the time of redisplay is also conceivable.

If the user issues an instruction to skip the contents reproduction to a start point of the next chapter (step 1426), then a series of processing shown as step 1480 is executed in order to conduct skip reproduction.

First, at the step 1480, the control apparatus 150 requests the receiving apparatus 130 to interrupt the reproduction of the pertinent contents (step 1427). Upon receiving the request, the receiving apparatus 130 requests the transmitting apparatus 110 to stop the transmitting of the pertinent contents (step 1455).

Upon receiving the transmitting stop request, the transmitting apparatus 110 stops the transmitting of the pertinent contents (step 717). Thereafter, the control apparatus 150 acquires the chapter position 1024 of a chapter disposed immediately after the reproduction position in time, on the basis of the reproduction position of contents received at the step 1424 (or corrected by using the time information according to the clock). And the control apparatus 150 requests the receiving apparatus 130 to start contents reproduction by specifying a reproduction start position on the basis of position information of contents indicated in the chapter position (step 1428).

Upon receiving the request, the receiving apparatus 130 requests the transmitting apparatus 110 to start contents transmitting by specifying the pertinent reproduction start position as the transmitting start position (step 1456). The transmitting apparatus 110 conducts content data transmitting in response to the contents transmitting start request issued at the step 1456 by using the contents transmitter 206 (step 718). The receiving apparatus 130 resumes the reproduction of the contents in the same way as the step 1453 (step 1457).

If the contents reproduction position has arrived at a part of the contents which is not viewed described with reference to FIG. 8, the control apparatus 150 detects arrival at a start point of the chapter monitored beforehand at the series of steps 1490 (=step 1429) and then executes a series of processing at the step 1480 described above.

If the user instructs to insert a chapter in a certain position of the contents (by operating on a screen as shown in FIG. 8) (step 1435), then the control apparatus 150 first the series of steps 1490 to acquire the insertion position instructed by the user (step 1434).

And the control apparatus 150 generates the chapter information 630 and transmits it to the transmitting apparatus 110 in order to set the acquired information in the transmitting apparatus 110 (step 1435). This is conducted according to a method described in the action list 510 (by using the action name 514 and the arguments 515 and 516).

Upon receiving the (setting) request for the chapter information 630, the transmitting apparatus 110 generates and writes chapter information 612 and/or 642 of the pertinent contents on the basis of a value of ChapterList described in the argument 516 by following the network delivery contents information 620, the intra recording medium contents information 610, and the expanded chapter information 640 on the basis of the value of ObjectID described in the argument 512 (step 721).

If the user stops the reproduction of the contents (step 1436), then the control apparatus 150 requests the receiving apparatus 130 to stop the reproduction of the contents (step 1437). Upon receiving the request, the receiving apparatus 130 requests the transmitting apparatus 110 to stop the transmitting of the pertinent contents (step 1458), and the transmitting apparatus 110 stops the transmitting of the pertinent contents.

Then, the control apparatus 150 compares the default chapter list number 1002 in the chapter information 632 (=the chapter information 1000) received from the transmitting apparatus 110 with a number of a chapter list selected lastly by the user (the present step is not illustrated). If there is a difference as a result of the comparison, then the control apparatus 150 generates (updates) the chapter information 630 and transmits it to the transmitting apparatus 110 in the same way as the step 1435 (step 1438).

Upon receiving the (setting) request for the chapter information 630, the transmitting apparatus 110 updates the chapter information 612 and/or 642 in the same way as the step 721 (step 722).

By doing as described heretofore, not only the control apparatus acquires chapter configuration information from the transmitting apparatus (server), presents this information to the user, and controls the receiving apparatus (client) on the basis of an operation such as skip of the user, but also it becomes possible to cause the server to set chapter configuration information which is set (inserted or updated) by the control apparatus. In addition, it becomes possible to manage the chapter information of contents on the home network.

Furthermore, even in the case where the chapter information is formed of a plurality of chapter lists according to the significance of chapter information, it becomes possible for the server and the control apparatus to acquire its configuration information from each other. Its configuration information has a common configuration which does not depend upon the recording medium, and the server is configured to convert chapter configuration information which depends upon the recording medium to this common configuration. As a result, it becomes possible for the control apparatus to interpret the chapter information without being conscious of (the recording medium in) the server.

In the above-described embodiment, it has been described that the transmitting apparatus shown in FIG. 2, the receiving apparatus shown in FIG. 3, and the control apparatus shown in FIG. 13 have blocks 201 to 222, blocks 301 to 312, and blocks 1301 to 1312, respectively. In each apparatus, functions of these blocks and functions which are not illustrated may be implemented by using one CPU or a plurality of CPUs. For example, functions of the blocks 204, 205, 206, 207, 210 and 220 may be implemented by using one CPU. The same is true of the apparatus shown in FIG. 11.

The steps described with reference to FIG. 7 or FIG. 14 are not restricted to the illustrated order, but may be interchanged suitably. For example, in FIG. 14, the processing at the steps 1411 to 1413 and the processing at the steps 1414 to 1415 may be interchanged in order, to select an apparatus for reproducing contents earlier and then conduct processing on the server.

It should be further understood by those skilled in the art that although the foregoing description has been made on embodiments of the invention, the invention is not limited thereto and various changes and modifications may be made without departing from the spirit of the invention and the scope of the appended claims.

1. A content transmitting unit which reproduces content read from a recording medium to transmit the reproduced content to a receiving unit via a network, comprising:
a content reproduction unit which reproduces the content read from the recording medium;
a content information management unit which manages content information including chapter information of the content; and
an interface unit which communicates with the receiving unit via the network, wherein
when the interface unit receives a request for chapter information of a content from the receiving unit, the interface unit transmits the chapter information of the content to the receiving unit, and
when the interface unit receives a sending request of the content beginning at a position required based on the chapter information of the content from the receiving unit, the content reproduction unit reproduces the content from a requested position and the interface unit sends the reproduced content to the receiving unit.

2. The content transmitting unit according to claim 1, wherein the chapter information is chapter list information which includes information of one or a plurality of chapters.

3. The content transmitting unit according to claim 2, wherein
upon receiving a request from the receiving unit, the content transmitting unit transmits to the receiving unit device information indicating that the content transmitting unit is associated with the chapter information.

4. The content transmitting unit according to claim 1, wherein
the content transmitting unit transmits list information including ID information of content that the content transmitting unit can transmit to the receiving unit, and
upon receiving a request for the chapter information of the content identified by the ID information from the receiving unit, the content transmitting unit transmits the chapter information of the identified content to the receiving unit.

5. A content receiving unit which receives content transmitted from a transmitting unit via a network, comprising:
an interface unit which communicates with the transmitting unit via the network;
a content processing unit which processes the received content to display the received content; and
a content reception unit which receives the content from the transmitting unit via the network,
wherein
the content processing unit transmits a request for chapter information of content to the transmitting unit via the interface unit and obtains the chapter information of the content from the transmitting unit,
the content processing unit obtains a position indicated by a chapter using the obtained chapter information, and
the content processing unit transmits a transmission request of content beginning at the position indicated by the chapter to the transmitting unit via the interface unit to obtain the content from the transmitting unit.

6. The content receiving unit according to claim 5, wherein the chapter information is chapter list information which includes information of one or a plurality of chapters.

7. The content receiving unit according to claim 5,
wherein the content receiving unit obtains device information from the transmitting unit and obtains the chapter information when it is confirmed that the transmitting unit is associated with the chapter information.

8. The content receiving unit according to claim 5, wherein
the content receiving unit obtains list information including ID information of contents that the content transmitting unit can transmit from the transmitting unit, and
the content receiving unit transmits a request for chapter information of a content identified by the ID information to the transmitting unit to obtain the chapter information of the identified content from the content transmitting unit.

9. A content transmitting and receiving method for receiving at a receiving unit a content read from a recording medium, reproduced and transmitted by a transmitting unit via a network, comprising the steps of
by the receiving unit, sending a request for chapter information of the content to the transmitting unit;
by the transmitting unit, sending the chapter information of the content to the receiving unit upon receiving the request for chapter information;
by the receiving unit, obtaining the position indicated by a chapter using the received chapter information and transmitting a request for content transmission from the obtained position to the transmitting unit; and
by the transmitting unit, reproducing the content from the requested position to send the reproduced content to the receiving unit upon receiving the request for content transmission from the receiving unit.

10. The content transmitting and receiving method according to claim 9, wherein the chapter information is chapter list information which includes information of one or a plurality of chapters.

11. The content transmitting and receiving method according to claim 9, further comprising the step of:
by the transmitting unit, transmitting to the receiving unit device information indicating that the content transmitting unit is associated with the chapter information upon receiving a request from the receiving unit.

12. The content transmitting and receiving method according to claim 9, further comprising the steps of:
by the transmitting unit, transmitting list information including ID information of contents that the content transmitting unit can transmit to the receiving unit, and
by the receiving unit, transmitting the request for chapter information of the content identified by the ID information to the transmitting unit to obtain the chapter information of the content from the transmitting unit.

13. A content receiving method in a content receiving unit for receiving a content transmitted from a transmitting unit via a network, comprising the steps of:
sending a request for chapter information of the content to the transmitting unit to obtain the chapter information of the content;
obtaining the position indicated by a chapter using the received chapter information; and
transmitting a request for content transmission from the position indicated by the chapter to the transmitting unit to obtain the content from the transmitting unit.

14. The content receiving method according to claim 13, wherein the chapter information is chapter list information which includes information of one or a plurality of chapters.

15. The content receiving method according to claim 13, further comprising the step of:
obtaining device information of the transmitting unit from the transmitting unit and obtaining the chapter information when it is confirmed that the transmitting unit is associated with the chapter information.

16. A content reproduction control apparatus connected to a transmitting unit to transmit a content via a network and a receiving unit to receive the content via a network for controlling the transmitting unit and the receiving unit, comprising:
a network interface for receiving information transmitted from the transmitting and receiving units and for transmitting information to the transmitting and receiving units, wherein:
the content reproduction control apparatus obtains from the transmitting unit, chapter information of the content, and then transmits to the receiving unit an indication to reproduce the content beginning at the position indicated by the chapter information.

17. The content reproduction control apparatus according to claim 16, wherein, when the reproduction of the content is suspended, the content reproduction control apparatus obtains the information indicating a position at which the content is displayed from the receiving unit and generates the chapter information using the obtained information to send the generated chapter information to the transmitting unit.

18. The content reproduction control apparatus according to claim 16, wherein,
the content reproduction control apparatus obtains, from the transmitting unit, device information including information indicating that the transmitting unit is associated with the chapter information; and
if the obtained device information includes the information indicating that the transmitting unit is associated with the chapter information, the content reproduction control apparatus sends and receives chapter information to and from the transmitting unit.

19. The content reproduction control apparatus according to claim 16, wherein the chapter information is chapter list information which includes information of one or a plurality of chapters.

20. A content reproduction control method of controlling a transmitting unit to transmit a content via a network and a receiving unit to receive the content via a network, the method comprising the steps of:
obtaining from the transmitting unit, chapter information;
transmitting to the receiving unit, an indication to obtain and display the content beginning at the position which is indicated by the obtained chapter information;
obtaining from the receiving unit, content reproducing information indicating a position at which the content is to be reproduced;
transmitting an indication to stop acquisition of the content to the receiving unit;
creating chapter information by use of the content reproducing information obtained from the receiving unit; and
transmitting the chapter information to the transmitting unit.

21. The content reproduction control method according to claim 20, further comprising the steps of:
obtaining from the transmitting unit, device information including information indicating that the transmitting unit is associated with the chapter information; and
receiving, if the obtained device information includes information indicating that the transmitting unit is associated with the chapter information, the chapter information from the transmitting unit and transmitting the chapter information to the transmitting unit.

22. The content reproduction control method according to claim 20, wherein the chapter information is chapter list information which includes information of one or a plurality of chapters.
